(19) United States
(12) Patent Application Publication
(10) Pub. No.: US 2025/0320840 A1
(43) Pub. Date: Oct. 16, 2025

(54) DEVICE FOR APPLYING A CLOSED LOOP COMBUSTION CONTROL TO AN ENGINE AND METHOD THEREFOR

(71) Applicant: Liebherr-Components Colmar SAS, Colmar Cedex (FR)

(72) Inventor: Nicolas BLEICHNER, Colmar (FR)

(21) Appl. No.: 19/170,635

(22) Filed: Apr. 4, 2025

(30) Foreign Application Priority Data
Apr. 10, 2024 (DE) 10 2024 110 013.3

(51) Int. Cl. F02D 41/14; F02D 41/26

(52) U.S. Cl. CPC F02D 41/1402; F02D 41/263; F02D 2041/1422

(57) ABSTRACT

The present disclosure relates to a device for applying a closed-loop combustion control for an engine having plural cylinders, comprising: a plurality of fuel injectors for supplying fuel into each one of the plurality of cylinders of the engine, a plurality of pressure sensors, wherein in or at each of the plurality of cylinders one of the plurality of pressure sensors is arranged for determining the pressure therein, and an electronic control unit for receiving the sensor values obtained by the plurality of pressure sensors and for controlling injection parameters of the plurality of fuel injectors, optionally for controlling fuel quantity and/or injection timing, wherein the electronic control unit is configured to individually perform a closed-loop combustion control strategy for each of the cylinders of the engine.

### CROSS REFERENCE TO RELATED APPLICATION

The present application claims priority to German Patent Application No. 10 2024 110 013.3 filed on Apr. 10, 2024. The entire contents of the above-listed application are hereby incorporated by reference for all purposes.

### TECHNICAL FIELD

The present disclosure relates to a device for applying a closed loop combustion control to an engine and a method therefor.

### BACKGROUND

An internal combustion engine typically consists of one or more cylinders that each house a piston capable of reciprocating movement. The piston is connected to and drives a crankshaft. The cylinder head, cylinder, and reciprocating piston together define the combustion chamber. To initiate the piston's movement, a fuel and air mixture is introduced into the combustion chamber and ignited.

### SUMMARY

Each cylinder contains at least one fuel injector that injects the necessary amount of fuel at high pressure. These fuel injectors are controlled either mechanically by a camshaft or an electronic drive.

For a typical internal combustion engine to operate reliably, with low vibration and in compliance with emission regulations, it is crucial to achieve balanced combustion across its multiple cylinders. However, several factors can cause variability in the combustion process, both from one cylinder to another and from one cycle to the next. These factors may include mechanical construction, such as differences in stroke length, head and piston heights, gasket and ring sizes, camshaft profiles, fuel manifold, and wave harmonics, among others. Additionally, engine and component condition can play a role, with worn rings, weak lifters, leaking fuel valves, spark plug and ignition coil degradation (in the case of spark ignition engines), and other issues potentially contributing to combustion variability. Finally, combustion controls, including air/fuel ratio, ignition timing, engine cooling, and other factors, may also impact the combustion process.

One of the technologies for enhancing the performance of internal combustion engines is closed-loop combustion control, which relies on in-cylinder pressure sensors. This type of control mechanism involves a combination of both hardware and software components. Hardware components include in-cylinder pressure sensors and control units that process the raw sensor data and convert it into combustion parameters. The software components then process these parameters and generate specific control values for each of the fuel injectors.

The in-cylinder pressure sensors are used to monitor the combustion state in each cylinder, and this information is used to improve the combustion condition and therefore improve engine robustness, fuel efficiency, pollutant emission level, vibration and engine overall performance, by having the same combustion state and combustion output in each cylinder.

Document U.S. Pat. No. 10,337,429B1 shows a control apparatus and method for internal combustion engine cylinder balance based on in-cylinder pressure measurements, where the feedback controller is using gain scheduling do adapt to engine operation.

However, a simple feedback controller will have difficulties to achieve balanced combustion across multiple cylinders.

The object of the present disclosure is therefore to provide an improved device for applying a closed-loop combustion control for an engine having a plurality of cylinders.

This object is solved by a device as described herein.

The present disclosure provides a device for applying a closed-loop combustion control for an engine having a plurality of cylinders, comprising: a plurality of fuel injectors for supplying fuel into each one of the plurality of cylinders of the engine; a plurality of pressure sensors, wherein in or at each of the plurality of cylinders one of the plurality of pressure sensors is arranged for determining the pressure therein, and an electronic control unit for receiving the sensor values obtained by the plurality of pressure sensors and for controlling injection parameters of the plurality of fuel injectors, optionally for controlling fuel quantity and/or injection timing, wherein the electronic control unit is configured to individually perform a closed-loop combustion control strategy for each of the cylinders of the engine. The disclosure is characterized in that the electronic control unit is configured to, when performing the closed-loop combustion control strategy of each cylinder, apply a three level combustion control strategy for controlling at least one injection parameter of the cylinder using: a base compensation map comprising individual compensation values for the injection parameter of each one of the cylinders, the individual compensation values optionally used to adapt nominal control values of a base map common to all cylinders; an adaptive map comprising correction values for the injection parameter of each one of the cylinders, the correction values being determined during operation of the engine, the correction values optionally being used to correct the compensation values of the base compensation map; and
a feedback controller for feedback-controlling the injection parameter based on a sensor value of the corresponding pressure sensor to obtain a target value for a combustion parameter of the cylinder.

The present disclosure takes into account that at the end of the production line, actuators such as fuel injectors may not be identical but vary from part to part. Additionally, over time, these fuel injectors may age, resulting in different outputs when applying identical control values. Further, the configuration of the engine will equally have an impact on the combustion that may be different in each cylinder. When operating in an open-loop combustion system without feedback on the combustion state, these variations can lead to differences in the amount of fuel injected and the timing of injection among cylinders, as well as different combustion conditions due to the engine configuration, even when the same control values are sent to the plurality of fuel injectors.

The inventors of the present disclosure have realized that even with a feedback controller, these differences lead to a deterioration of the engine performance, because the feedback controller will have difficulties in compensating for them.

The present disclosure therefore provides, in addition to the feedback controller, a fixed base compensation map and an adaptive map that compensate for differences in the combustion due to the engine configuration and differences between injectors, and thereby improves balancing of the cylinders.

In an embodiment, the base compensation map takes into account differences between individual cylinders which are due to the engine design. The adaptive map allows to take into account unavoidable differences between fuel injectors for each cylinder and also the fuel injector aging over its lifetime. The feedback controller is used to correct any remains of deviation between the target value and the combustion parameter.

In an embodiment, the electronic control unit is configured to determine the correction values from a change of the feedback controller's filter coefficients over time at the same or a similar engine operating condition. Therefore, the adaptive map is filled while the engine is running. Thus, the adaptive map provides a learning function to adapt to differences between the injectors as well as to the injector's ageing over time.

The first level of the three level closed-loop combustion control may be the base compensation exerted by the base compensation map. For example, a correction value may be added to a nominal value of the injector control parameter taken from a base compensation map common to all cylinders.

The second level is the adaptive map which takes into account differences between the injectors and aging of the injector over its lifetime. As already explained above, the correction values for the adaptive map may be derived from the static correction part of the feedback controller. Whenever there is a change in the static correction part of the controller, a respective entry in the adaptive map is updated.

The third level is the feedback controller for feedback-controlling the injection parameter based on a sensor value of the corresponding pressure sensor to obtain a target value for a combustion parameter of the cylinder.

In an embodiment, the electronic control unit provides the three-level control strategy for at least two injection parameters separately, optionally for the fuel quantity and/or injection timing of the injectors.

Therefore, in an embodiment, the electronic control is provided with separate feedback controllers for controlling fuel quantity and injection timing, as well as a base compensation map and an adaptive map both for fuel quantity and injection timing for each cylinder.

In an embodiment, the electronic control unit is configured to compensate one injection parameter depending on a change in the other parameter. Thereby, the separate controllers for the at least two injection parameters are interlinked, such that a change in the one parameter is taken into account in the control of the other parameter in order to avoid a disturbance in the control.

In an embodiment, the electronic control unit is configured to compensate injection timing depending on a change in fuel quantity.

In an embodiment, the electronic control unit is configured to determine a correction factor to adapt the base map, in particular a fuel quantity base map and injection timing base map, to a fuel quality of the fuel used. By this, it's possible to adopt operation of the engine to the fuel quality.

In an embodiment, the electronic control unit is configured to estimate the fuel quality on the basis of the sensor values of the pressure sensors.

In particular, the electronic control unit may be configured to analyze the combustion state parameters and to estimate the fuel quality with which the engine is operated.

In an embodiment, the electronic control unit is configured to provide gain scheduling of the feedback controllers to adapt the reactivity of the feedback controllers between a steady state and a transient condition of the engine.

In an embodiment, the electronic control unit is configured to process the sensor data received from the plurality of pressure sensors to determine at least one combustion parameter for each one of the plurality of cylinders, wherein the combustion parameter is optionally used as input for the feedback controller.

In an embodiment, the device further comprises at least one crankshaft position sensor for determining a crankshaft position, and the electronic control unit is configured to determine the at least one combustion parameter for each one of the plurality of cylinders based on the sensor values of an associated pressure sensor and the crankshaft position sensor.

In an embodiment, the combustion parameter is at least one out of:
a maximum pressure (Pmax) that occurs in the cylinder's combustion chamber during the power stroke,
an average pressure exerted on the cylinder's piston (IMEP) during the power stroke,
a cylinder's crankshaft angle at which 50% of the fuel's energy has been released (CA50) during the combustion process, and/or
a cylinder's crankshaft angle at which 50% of the fuel mass has been burned (MFB50) during the combustion process.

Pmax stands for Maximum Pressure and refers to the maximum pressure that occurs in the combustion chamber of an engine during the power stroke. The power stroke is the phase of the engine cycle during which the piston is pushed down by the expanding gases produced by the combustion of the fuel-air mixture.

IMEP stands for Indicated Mean Effective Pressure. IMEP is a parameter that is commonly used to evaluate the performance of the engine and represents the average pressure exerted on the piston during the power stroke of the engine. It is calculated based on the pressure measured inside the combustion chamber by means of the pressure sensors.

CA50 stands for Crank Angle at 50% Heat Release. CA50 is a metric that represents the crankshaft angle at which 50% of the fuel's energy has been released during the combustion process and provides information about the timing of the combustion process. CA50 can also be used as an indicator of the combustion quality and stability, and may help to diagnose potential problems with the engine, such as misfires or incomplete combustion.

MFB50 is a metric that is used to evaluate the timing of the combustion process. It represents the crank angle at which 50% of the fuel mass has been burned during the combustion process. MFB50 is a useful parameter for deriving modifications in order to optimize the engine's performance.

In an embodiment, the electronic control unit is further configured to, when performing the closed-loop combustion control, control the plurality of fuel injectors with their respective injection parameters one after the other in a subsequent manner.

Thus, the control scheme of the closed-loop combustion control is configured to control only the injection parameters of one fuel injector at a time. After the control is finished, the injection parameters of the next fuel injector are subjected to feedback control. This significantly reduces the necessary computing resources as it is not necessary to simultaneously compute injection parameter(s) of a plurality of fuel injectors.

In an embodiment, the electronic control unit is configured to evaluate the plurality of cylinders with respect to at least one combustion parameter and to apply the closed-loop combustion control to the fuel injector of the cylinder having the greatest deviation from a target value of the combustion parameter.

In an embodiment, the electronic control unit is configured to repeat said evaluation and the subsequent closed-loop combustion control to a specific fuel injector of a cylinder until all of the plurality of cylinders lie within a target range of the combustion parameter.

In an embodiment, the injection parameters controlled by the present disclosure comprise energizing time and/or injection timing of the fuel injector. Energizing time defines how long the injector is applied with a respective control value, for example how long the signal for injecting fuel into the combustion chamber should be applied and therefor directly influences the amount of fuel injected. The injection timing of the fuel injector decides when the fuel injector is to be operated in order to inject a specific amount (defined by the energizing time) of fuel into the combustion chamber. Thus, energizing time affects the fuel quantity dispensed by a respective fuel injector whereas injection timing defines when the fuel is injected.

The present application further comprises a method for applying a closed-loop combustion control to an engine, optionally by means of a device as described above, wherein the method comprises the steps of:
measuring the pressure in each one of the plurality of cylinders during a combustion cycle,
optionally, determining the crankshaft position for each one of the plurality of cylinders during a combustion cycle,
determining, based on the pressure values, and optionally the crankshaft position, at least one combustion parameter for each one of the plurality of cylinders and performing a closed-loop combustion control using the combustion parameter as input to individually control at least one injection parameter of the respective cylinder, wherein, when applying the closed-loop combustion control, the injection into the plurality of cylinders is feedback-controlled one after the other in a subsequent manner.

Thus, the feedback control values are determined one after another for the plurality of injectors of the engine.

Thus, the control scheme of the closed-loop combustion control is configured to control only the injection parameters of one fuel injector at a time. After the control is finished, the injection parameters of the next fuel injector are subjected to feedback control. This significantly reduces the necessary computing resources as it is not necessary to simultaneously compute injection parameter(s) of a plurality of fuel injectors.

In an embodiment, the closed-loop combustion control is first applied to a cylinder having the greatest deviation of the combustion parameter from a target value.

In an embodiment, when performing the closed-loop combustion control strategy of each cylinder, a three level combustion control strategy for controlling at least one injection parameter of the cylinder is applied using: a base compensation map comprising individual compensation values for the injection parameter of each one of the cylinders, the individual compensation values optionally used to adapt nominal control values of a base map common to all cylinders, an adaptive map comprising correction values for the injection parameter of each one of the cylinders, the correction values being determined during operation of the engine, the correction values optionally being used to correct the compensation values of the base compensation map, and feedback-controlling the injection parameter based on a sensor value of the corresponding pressure sensor to obtain a target value for a combustion parameter of the cylinder.

In particular, the method may be performed as already described above with respect to the device.

The present disclosure further comprises an engine comprising a device as described above or comprising a controller configured to perform the method described above.

The present disclosure further comprises a corresponding electronic control unit and/or controller.

The electronic control unit and/or controller may comprise a microprocessor and a computer program stored in non-transitory memory, wherein the computer program, when running on the microprocessor, will perform the above indicated method or implement the functionality of the device described above. The microprocessor may be connected to the sensors and actors described above by signal connections, and in particular may receive sensor values from the pressure sensors and crank angle sensor and/or send control commands to the injectors. The electronic control unit and/or controller may in particular be configured to automatically and/or autonomously perform the described method steps or perform the described control.

### BRIEF DESCRIPTION OF THE FIGURES

Further features, details and advantages of the disclosure will be apparent from the following figures. The figures show:

FIG. 1: a schematic overview of the closed-loop combustion control of the disclosure,

FIG. 2: a diagram showing the variations of Pmax for all of the 16 cylinders of an engine,

FIG. 3a: a diagram showing the variations of IMEP for all of the 16 cylinders of an engine,

FIG. 3b: a diagram showing the variations of CA50 for all of the 16 cylinders of an engine,

FIG. 4: a diagram showing the deviations of Pmax, IMEP and CA50 of each of the 16 cylinders of an engine with respect to their respective mean value,

FIG. 5: a diagram showing the desired results of IMEP balancing,

FIG. 6: and exemplary fuel injection control strategy for IMAP balancing according to the disclosure,

FIG. 7: an overview of the results when applying the fuel injection control strategy according to the disclosure for each one of a plurality of cylinders, and

FIG. 8: a schematic diagram for a three level closed-loop combustion control controlling energizing time and injection timing of the fuel injector.

### DETAILED DESCRIPTION

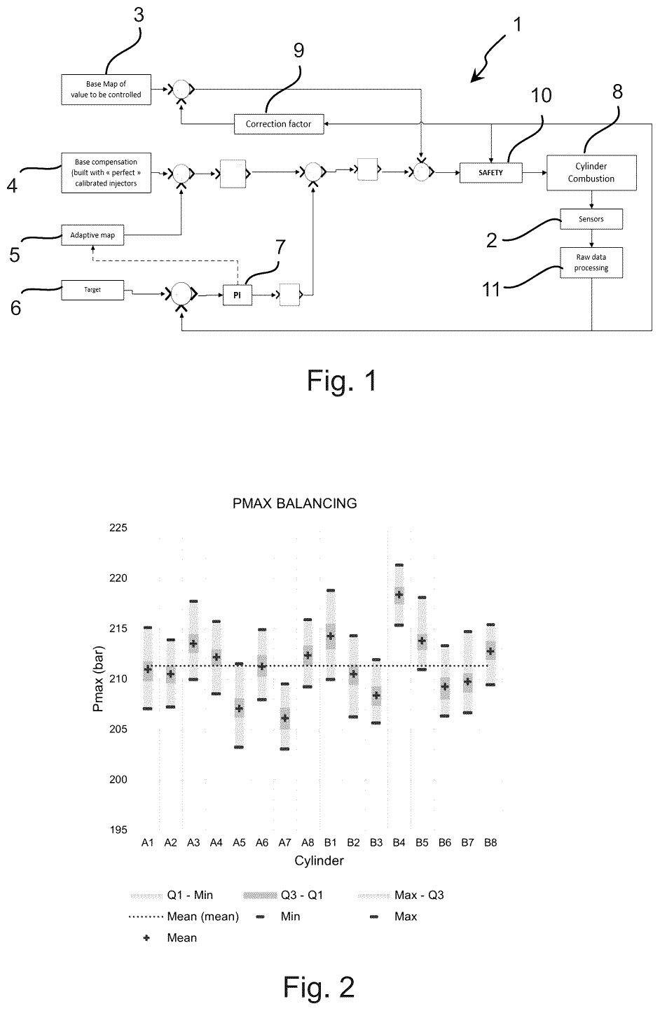

FIG. 1 shows a schematic overview of the three level closed-loop combustion control 1 according to the present disclosure.

As can be seen in FIG. 1, a base map 3 comprises the same control values for all the fuel injectors, such as the energizing time of a fuel injector or the injection timing of a fuel injector. The map provides the control value depending on at least one input value, such as an operation condition of the engine or a target combustion parameter.

The base map 3, which is used for the control of all cylinders, may be corrected in order to adopt to the fuel quality used by the engine, as described in the following.

The values provided by the base map 3 are combined with correction values provided by a static base compensation map 4 provided for each fuel injector, in order to adapt the control for each specific fuel injector to the engine configuration in order to balance the engine output and. The correction values are taken from the base compensation map 4 comprising correction values for each cylinder and its corresponding fuel injectors in order to mitigate any unbalances finding reason in the engine type. Thus, the correction values of the base compensation map 4 do not take into account for differences between the actual fuel injectors equipped to the engine but were obtained assuming perfectly calibrated fuel injectors. As a result, the base compensation map 4 comprises static correction values that correct inherent unbalances due to the engine type.

Pressure sensors and/or crankshaft angle sensors 2 may be used in order to derive the current combustion parameters, for example a maximum pressure (Pmax) that occurs in the cylinder's combustion chamber of the engine during the power stroke, an average pressure exerted on the cylinder's piston (IMEP) during the power stroke of the engine, a cylinder's crankshaft angle at which 50% of the fuel's energy has been released (CA50) during the combustion process, and/or a cylinder's crankshaft angle at which 50% of the fuel mass has been burned (MFB50) during the combustion process. The combustion parameters are obtained by processing the raw data of the sensor(s).

Further, in addition to the base correction map 4, a feedback controller 7 such as a PI controller or a PID controller is provided in order to perform a feedback control with respect to a target value 6 for at least one combustion parameter of the engine. Thus, the value from the base compensation map 4 is further corrected by the PI controller or the PID controller 7.

The target value may be taken from a lookup table of the respective combustion parameter (for example an IMEP look-up table), obtained by a physical model or an average value of the respective combustion parameter (Pmax, IMEP et cetera) over all combustion parameters of the plurality of cylinders.

Lastly, there is an adaptive map 5 taking into account the differences between fuel injectors of each cylinder and also the fuel injector's aging over its lifetime. The adaptive map 5 is filled while the engine is running when the static correction part of the PI controller or the PID controller 7 changes with respect to the previous value at similar or the same engine operating condition.

This means the adaptive map 5 is a learning function which is trying to compensate the fuel injector's aging over its lifetime. Thus, the adaptive map 5 remembers for a specific operating condition of the engine and its respective fuel injector a specific correction value in order to compensate any aging effects of said specific fuel injector.

Thus, with respect to its static part, it is not necessary that the PI controller or the PID controller 7 need to perform their feedback control in order to approach the target value, as the static part of said feedback control has already been taken into account by the adaptive map 5. This allows the device to set a perfectly or almost perfectly aligned control value for the fuel injector with respect to the injection parameter almost instantaneously without the need of performing a feedback control loop as would be necessary in case of absence of the adaptive map 5.

Thus, when setting a specific target value 6 for a respective combustion parameter of the engine, a correction value of the adaptive map 4 for the same or a similar operating condition of the engine is used in order to enhance the control scheme.

Together with the base compensation of the base compensation map 4 control values are obtained which very fast lead to the desired results of the combustion parameters as it is not necessary to perform a feedback loop in order to obtain the static parts of the PI controller or the PID control 7 (as they are stored for the specific operating condition of the engine in the adaptive map 5).

In summary, what is new with this disclosure is the possibility to have a base compensation, based on the engine natural behavior and design, for each cylinder independently. Additionally, filling the adaptive map 5 with respective values allows to take into account natural differences between fuel injectors for each one of the cylinders and also the fuel injector aging over its lifetime. The PI controller or the PID controller 7 is used to correct any remains of deviation between the target value and the engine output. This three level combustion control strategy is a very effective and fast control mechanism for combustion control needing very low computing resources.

FIG. 2 shows explanatory values for the maximum pressure exerted to the piston (Pmax) in a cylinder for an engine having 16 cylinders. As can be seen, there is a very high variance in the individual values of the cylinders. The mean value of the maximum pressure also significantly deviates over the plurality of cylinders. For example, the mean value of cylinder B 4 lies at 218 bar whereas the mean value for cylinder A 7 is at 206 bar.

As already explained above, this difference may for example be caused by small deviations in energizing time or injection timing which is caused by different behaviors of the fuel injectors (while the control values applies to the different fuel injectors are identical) or different properties of the combustion chambers.

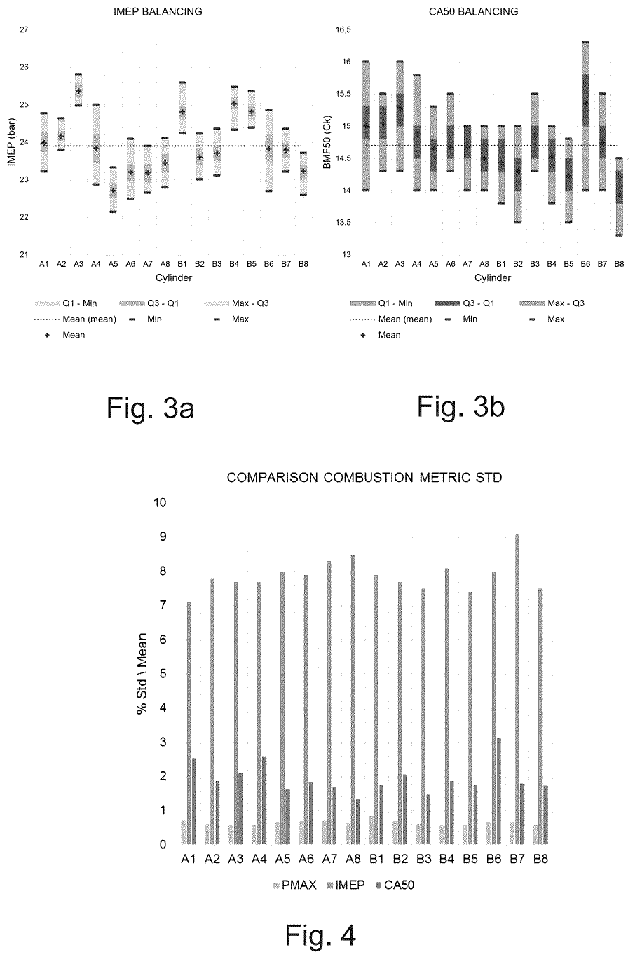

FIG. 3a shows the deviations of the engine's cylinders with respect to an average pressure exerted on the cylinder's piston during the power stroke of the engine (IMEP). As can be seen, the differences between the cylinders are remarkable, as the mean value of cylinder A 5 is at 22.7 bar whereas cylinder A 3 is showing an average pressure of about 25.4 bar.

The same can be seen with respect to the combustion parameter of CA50, indicating the cylinder's crankshaft angle at which 50% of the fuel's energy has been released, depicted in FIG. 3b. Cylinder B 8 indicates a mean angle of 13.9 whereas cylinder B 6 indicates a mean angle of 15.3.

FIG. 4 shows the deviations of the combustion parameters discussed in FIGS. 2, 3a and 3b. This deviation may be caused by cylinders to cylinder variations or cycle to cycle variations.

Cylinder to cylinder variation can be caused by various factors throughout the engine and injector production, assembly, and operation process. Firstly, injectors production can lead to variations in fuel delivery to the cylinders, which can affect the combustion process and lead to cylinder-to-cylinder variation.

Secondly, engine parts production can also have an impact on cylinder-to-cylinder variation, as any differences in dimensions or tolerances between parts can affect the overall engine performance. This can be particularly problematic if the differences are significant enough to create imbalances between cylinders.

Thirdly, the engine/injectors assembling process can also contribute to cylinder-to-cylinder variation. This can include issues with gasket sealing, injector alignment, or other factors that can affect the precise operation of the engine and injectors.

Fourthly, cylinder water cooling can also play a role in cylinder-to-cylinder variation. If there are variations in the flow of coolant to different cylinders, this can affect the engine's temperature and ultimately its performance.

Fifthly, hardware aging can also cause cylinder-to-cylinder variation, as parts of the engine or injectors may wear differently over time, leading to imbalances in performance.

Sixthly, factors related to the intake air, such as quantity and swirl level, can also affect cylinder-to-cylinder variation. If there are differences in the air flow to different cylinders, this can impact the combustion process and lead to variations in performance.

Seventhly, residual gas quantity can also play a role in cylinder-to-cylinder variation. If there are differences in the amount of unburned fuel and exhaust gases left in the cylinder after combustion, this can affect the combustion process in subsequent cycles.

Eighthly, injection spray angle can also cause cylinder-to-cylinder variation. If the fuel spray angle is not consistent between cylinders, this can affect the way the fuel is distributed and ultimately impact performance.

Lastly, local/global lambda, which refers to the air/fuel ratio in the individual cylinders versus the overall engine, can also cause cylinder-to-cylinder variation. If there are differences in the air/fuel ratio between cylinders, this can affect the combustion process and lead to variations in performance.

Cycle-to-cycle variation can also be caused by several factors that affect the combustion process in each individual cylinder.

Firstly, the quantity of intake air can have an impact on cycle-to-cycle variation, as variations in the amount of air entering the cylinder can affect the combustion process and ultimately the engine's performance.

Secondly, swirl level can also contribute to cycle-to-cycle variation. If there are differences in the level of swirl in the air/fuel mixture between cycles, this can affect the way the fuel is distributed and burned in the cylinder, leading to variations in performance.

Thirdly, residual gas quantity can also play a role in cycle-to-cycle variation. If there are differences in the amount of unburned fuel and exhaust gases left in the cylinder after combustion, this can affect the combustion process in subsequent cycles and lead to variations in performance.

Fourthly, injection pressure can also cause cycle-to-cycle variation, as differences in the pressure at which fuel is injected into the cylinder can affect the combustion process and ultimately impact engine performance.

Fifthly, local/global lambda, which refers to the air/fuel ratio in the individual cylinders versus the overall engine, can also cause cycle-to-cycle variation. If there are differences in the air/fuel ratio between cycles, this can affect the combustion process and lead to variations in performance.

Sixthly, diffusion combustion rate can also contribute to cycle-to-cycle variation. If there are differences in the rate at which fuel diffuses and mixes with air in the cylinder, this can affect the combustion process and lead to variations in performance.

Lastly, vaporization can also play a role in cycle-to-cycle variation. If there are differences in the way fuel vaporizes and mixes with air in the cylinder, this can affect the combustion process and ultimately impact engine performance. Overall, these factors can all contribute to cycle-to-cycle variation and must be carefully controlled in order to ensure consistent and reliable engine performance.

The variations discussed above can have negative impacts on the engine's efficiency, emissions levels, and power output capabilities. Inconsistent combustion processes can reduce the overall efficiency of the engine, while higher emissions can result from incomplete combustion or other issues. Additionally, power output limitations can arise due to imbalances between cylinders or other factors that negatively affect the engine's overall performance.

Thus, it is the objective of the present disclosure to compensate the fuel injectors ageing and dispersion causing the variance in the combustion parameters.

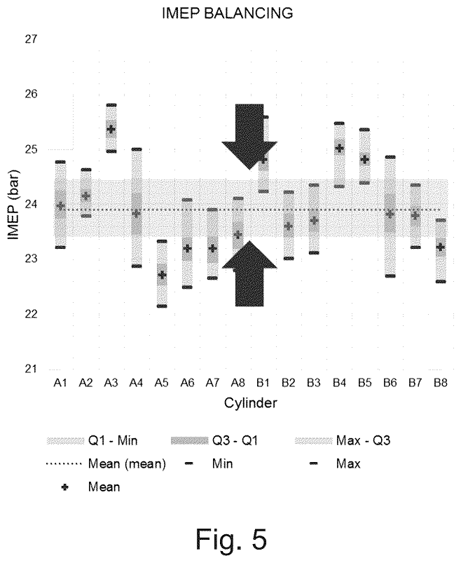

FIG. 5 shows the desired result on basis of the combustion parameter IMEP. As can be seen, it would be desirable to reduce the variance of the pressure exerted to the piston with respect to the plurality of cylinders of the engine. The red arrows show the bandwidth in which the mean values of the plurality of cylinders should lie in order to reduce the imbalances caused by differences in the pressure exerted to the pistons.

By having each cylinder delivering the same amount of torque on the crankshaft, vibration would be decreased and compensation of cylinder-to-cylinder variation would be obtained. The benefits which could be obtained therefrom lie again in fuel consumption, and engine protection through the maximum pressure limitation as well as a smoother engine operation and longer parts lifetime.

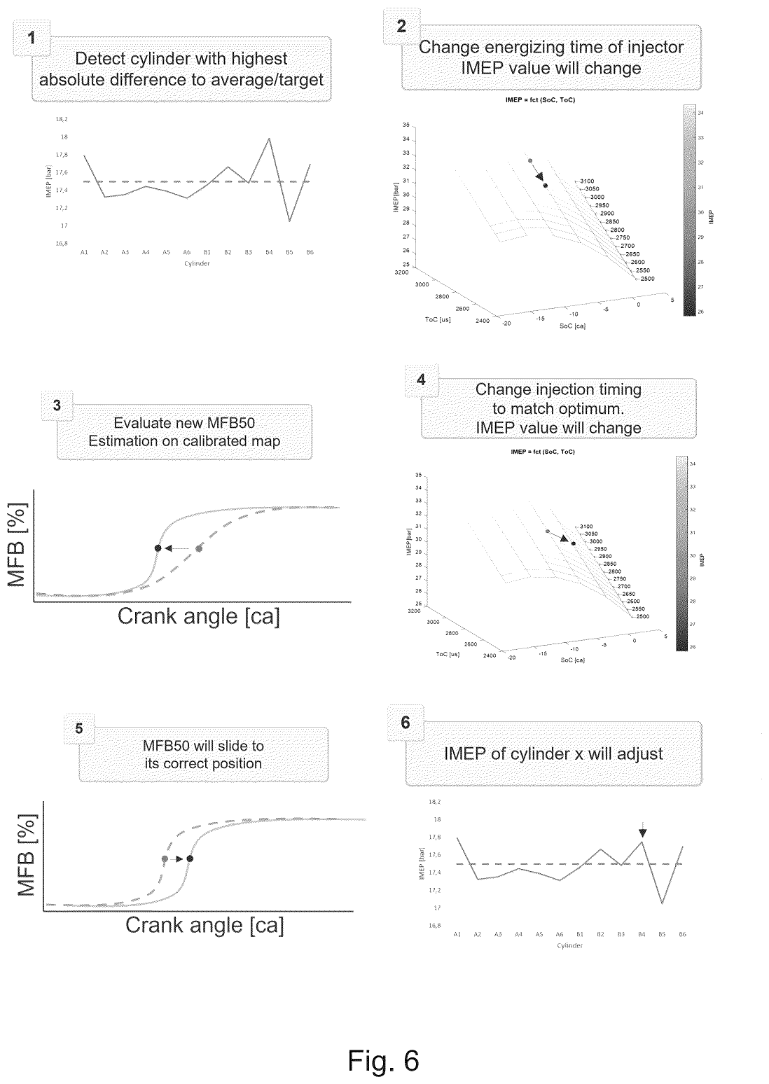

FIG. 6 shows a fuel injection control strategy according to the present disclosure for balancing IMEP.

First of all, the cylinder that exhibits the largest absolute deviation from the average or target value is identified (Step 1). Then, the injector energizing time to modify the IMEP (indicated mean effective pressure) value is changed (Step 2), and the impact of the new MFB50 (crank angle at 50% mass fraction burned) is evaluated by an estimation on the calibrated map (Step 3). Then, the injection timing to align with the optimal value is adapted (Step 4), which leads to changes in both the IMEP value and the MFB50 position (Step 5), causing the IMEP value of cylinder B4 to adapt accordingly (Step 6).

As can be seen, the IMEP value of cylinder B 5 is lowered in order to approach the mean of the IMEP value of all cylinders.

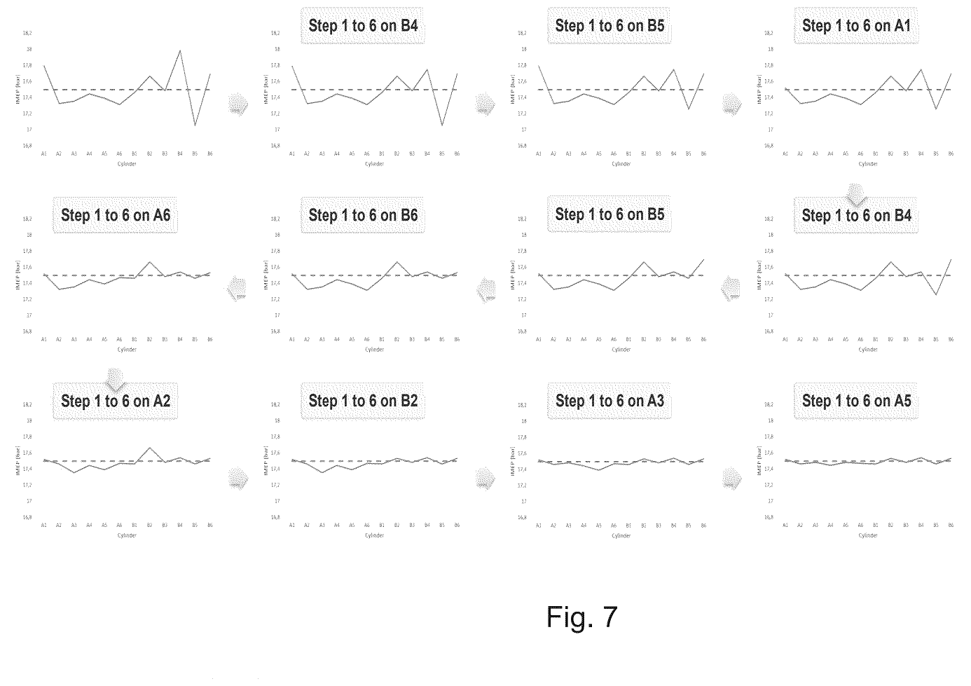

FIG. 7 shows the control strategy according to which the cylinder having the largest deviation from the mean value of the plurality of cylinders is subject to the injection control strategy as explained in FIG. 6, for example.

As can be seen, the deviations from the mean value gradually decreases when exerting the control strategy according to the present disclosure. The control is applied to the cylinder having the largest deviation from a target value. This is repeated until all combustion parameters of the cylinders lie within an acceptable range.

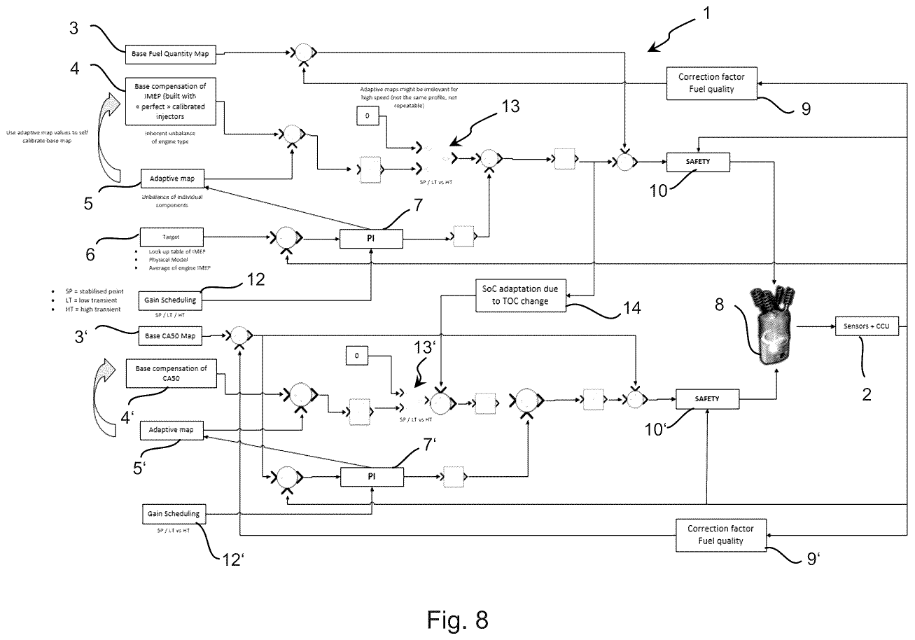

FIG. 8 shows a schematic diagram for a three level closed-loop combustion control controlling both energizing time and injection timing of the fuel injector.

An engine 8 has a certain number of cylinders, a certain number fuel injectors and pressure sensors which typically correspond to the number of cylinders. Further, a control unit is present which together with the sensors 2 processes the raw sensor data.

The engine control unit is further configured to control the fuel injectors of the engine.

The control strategy embedded in the engine control unit comprises a base fuel quantity engine map 3, a base compensation of the fuel quantity map 4 for each cylinder, an adaptive map 4 of the fuel quantity for each cylinder, and a feedback controller 7 receiving a target value 6 to control the fuel quantity.

Further, the engine control unit comprises a base injection timing engine map 3′, a base compensation of injection timing map 4′ for each cylinder, an adaptive map of injection timing 5′ for each cylinder, and a feedback controller 7′.

Further, both feedback controllers 7, 7′ comprise a gain scheduling component 12, 12′ and safety components 10, 10′.

Further, a fuel quality detection and adaption routine is provided, determining correction factor 9, 9′ to the values provided by the base maps to adapt for fuel quality.

Finally, a cross compensation unit 13 is provided for compensating injection timing depending on the change in fuel quantity/injection time.

The working principle of the closed-loop combustion control on the two injector control parameters of energizing time and injection timing is based on three levels, as describe above with respect to FIG. 1. Therefore, the description provided for FIG. 1 applies to each of the two controllers shown in FIG. 8 individually.

In particular, the energizing time control loop comprises three levels. The first level is the base compensation which is added to the nominal value of injector control parameter obtained from the base fuel quantity map 3. The base compensation is obtained by the base compensation map 4 which is specific to the injector concerned but static. The second level is the adaptive map 5 which is filled while the engine is running. The third level is the PI or the PID control 7 for correcting energizing time value. Further, as can be seen from the figure, there is a gain scheduling component 12 which is able to correct the system reactivity between steady-state entrance and condition of the engine. The adaptive map 5 is filled while the engine is running if the static correction part of the PI controller 7 changes compared to a previous value at similar engine operation conditions. Thus, this is a learning function of the injector taking into account the aging effects occurring over time.

The injection timing control loop also comprises said three levels, wherein the first level is a base compensation map 4′ which also adds to the nominal value of injector control parameter derived from base map 3′ to a control value. In addition to this base compensation, a compensation due to the change in energizing time must be added, in order to obtain the wanted injection timing. This is made by adaptation element 14. The second level, the adaptation map 5′ is filled while the engine is running. The third level, the PI or PID control 7′ serves to correct the injection timing value. A gain scheduling component 12′ is able to adopt correction system reactivity between steady-state and transient condition of the engine. The adaptation map 5′ is filled while the engine is running when the static correction part of the PID controller 7′ changes compared to a previous value at similar or the same engine operating condition. Thus, this is considered to be a learning function of the injector aging over time.

Further, the controller determines fuel quality, for example by evaluating the combustion parameters, and provides correction factors to adapt engine behaviour to the fuel quality.

The disclosure therefore independently controls each fuel injector's energizing time and injection timing, to improve the engine parameters by adapting to fuel quality and/or by balancing the engine output.

One of the novel aspects of the control is to have a static base compensation, based on the engine natural behavior and design, for each cylinders independently. In addition, an adaptive map can be filled; this allows taking into account natural differences between injectors for each cylinder, and also the fuel injector ageing over its lifetime. Finally, the PID controller is used to correct any remains of deviation between the targeted value and the engine output.

Thanks to the gain scheduling, this disclosure also allows to adapt the PID response, by adapting the gain and the feedback, to different operating conditions.

Further, the disclosure allows to adapt one fuel injector parameter when the other is changed, in order to respect the targeted values.

Finally, with the combustion state parameters, it is possible to estimate the fuel quality, to adapt the targeted values and optimize the fuel consumption no matter the fuel that is used.

1. A device for applying a closed-loop combustion control for an engine having a plurality of cylinders, comprising:
a plurality of fuel injectors for supplying fuel into each one of the plurality of cylinders of the engine,
a plurality of pressure sensors, wherein in or at each of the plurality of cylinders one of the plurality of pressure sensors is arranged for determining the pressure therein, and
an electronic control unit for receiving the sensor values obtained by the plurality of pressure sensors and for controlling injection parameters of the plurality of fuel injectors,
wherein the electronic control unit is configured to individually perform a closed-loop combustion control strategy for each of the cylinders of the engine,
wherein
the electronic control unit is configured to, when performing the closed-loop combustion control strategy of each cylinder, apply a three level combustion control strategy for controlling at least one injection parameter of the cylinder using:
a base compensation map comprising individual compensation values for the injection parameter of each one of the cylinders,
an adaptive map comprising correction values for the injection parameter of each one of the cylinders, the correction values being determined during operation of the engine, and
a feedback controller for feedback-controlling the injection parameter based on a sensor value of the corresponding pressure sensor to obtain a target value for a combustion parameter of the cylinder.

2. The device of claim 1, wherein electronic control unit is configured to determine the correction values from a change of the feedback controller's filter coefficients over time at the same or a similar engine operating condition.

3. The device of claim 1, wherein the electronic control unit provides the three-level control strategy for at least two injection parameters separately.

4. The device of claim 3, wherein the electronic control unit is configured to compensate one injection parameter depending on a change in the other parameter.

5. The device of claim 1, wherein the electronic control unit is configured to determine a correction factor to adapt the base map to a fuel quality of the fuel used, and/or
wherein the electronic control unit is configured to provide gain scheduling of the feedback controllers to adapt the reactivity of the feedback controllers between a steady state and a transient condition of the engine.

6. The device of claim 1, wherein the electronic control unit is configured to process the sensor data received from the plurality of pressure sensors to determine at least one combustion parameter for each one of the plurality of cylinders.

7. The device of claim 6, wherein
the device further comprises at least one crankshaft position sensor for determining a crankshaft position, and
the electronic control unit is configured to determine the at least one combustion parameter for each one of the plurality of cylinders based on the sensor values of an associated pressure sensor and the crankshaft position sensor.

8. The device of claim 6, wherein the combustion parameter is at least one out of:
a maximum pressure that occurs in the cylinder's combustion chamber during the power stroke,
an average pressure exerted on the cylinder's piston during the power stroke,
a cylinder's crankshaft angle at which 50% of the fuel's energy has been released during the combustion process, and/or
a cylinder's crankshaft angle at which 50% of the fuel mass has been burned during the combustion process.

9. The device of claim 1, wherein the electronic control unit is further configured to, when performing the closed-loop combustion control, control the plurality of fuel injectors with their respective injection parameters one after the other in a subsequent manner.

10. The device of claim 9, wherein the electronic control unit is configured to evaluate the plurality of cylinders with respect to at least one combustion parameter and to apply the closed-loop combustion control to the fuel injector of the cylinder having the greatest deviation from a target value of the combustion parameter.

11. The device of claim 10, wherein the electronic control unit is configured to repeat said evaluation and the subsequent closed-loop combustion control to a specific fuel injector of a cylinder until all of the plurality of cylinders lie within a target range of the combustion parameter.

12. A method for applying a closed-loop combustion control to an engine, wherein the method comprises the steps of:
measuring the pressure in each one of the plurality of cylinders during a combustion cycle,
determining, based on the pressure values, at least one combustion parameter for each one of the plurality of cylinders and performing a closed-loop combustion control using the combustion parameter as input to individually control at least one injection parameter of the respective cylinder, wherein, when applying the closed-loop combustion control, the injection into the plurality of cylinders is feedback-controlled one after the other in a subsequent manner.

13. The method of claim 12, wherein the closed-loop combustion control is first applied to a cylinder having the greatest deviation of the combustion parameter from a target value.

14. The method of claim 12, wherein, when performing the closed-loop combustion control strategy of each cylinder, a three level combustion control strategy for controlling at least one injection parameter of the cylinder is applied using:
a base compensation map comprising individual compensation values for the injection parameter of each one of the cylinders,
an adaptive map comprising correction values for the injection parameter of each one of the cylinders, the correction values being determined during operation of the engine, and
feedback-controlling the injection parameter based on a sensor value of the corresponding pressure sensor to obtain a target value for a combustion parameter of the cylinder.

15. An engine comprising a device according to claim 1.

16. The device of claim 1, wherein the injection parameters include fuel quantity and/or injection timing, the individual compensation values are used to adapt nominal control values of a base map common to all cylinders, and the correction values are used to correct the compensation values of the base compensation map.

17. The device of claim 4, wherein the electronic control unit is configured to compensate injection timing depending on a change in fuel quantity.

18. The device of claim 5, wherein the base map includes a fuel quantity base map, wherein the electronic control unit is configured to estimate the fuel quality on the basis of the sensor values of the pressure sensors.

19. The device of claim 6, wherein combustion parameter is used as input for the feedback controller.

20. The method of claim 12, further comprising:
determining the crankshaft position for each one of the plurality of cylinders during a combustion cycle, wherein the least one combustion parameter for each one of the plurality of cylinders is determined based on the pressure values and the crankshaft position.
